(19) United States
(12) Patent Application Publication
(10) Pub. No.: US 2019/0257508 A1
(43) Pub. Date: Aug. 22, 2019

(54) Multi-Party Prepared Beverage Order Polling and Consolidation

(71) Applicant: Michael Callahan, New York, NY (US)

(72) Inventor: Michael Callahan, New York, NY (US)

(21) Appl. No.: 16/197,948

(22) Filed: Nov. 21, 2018

Related U.S. Application Data
(63) Continuation of application No. 15/583,103, filed on May 1, 2017, now abandoned.
Application No. 15/583,103 is a continuation of application No. 14/676,575, filed on Apr. 1, 2015, now abandoned.
(60) Provisional application No. 61/973,592, filed on Apr. 1, 2014.

(51) Int. Cl. F21V 23/00; E04C 3/02; F21S 2/00; F21S 8/04

(52) U.S. Cl. CPC F21V 23/009; E04C 3/02; F21V 17/007; F21S 8/043; F21S 2/00

(57) ABSTRACT

A system and method of improving the process of assembling a multi-party order of individually prepared beverages is disclosed, making use of a customer's personal portable electronic device, such as a smartphone or tablet. The customer establishes a wireless link with the order management system of an enterprise preparing such beverage orders on its premises, whereby the customer can specify their own order. Reference is made to a record of the customer's nearby friends, relatives, and coworkers, who are automatically contacted via their personal electronic devices to determine whether and what they desire from the same enterprise. All responses are automatically collated an wirelessly transmitted to the enterprise for preparation without need of customer intervention.

This application relies upon Provisional Application 61/973,592 filed Apr. 1, 2014, included in its entirety by reference.

The application relates to various improvements related to the preparation and retailing of food and beverages.

### BACKGROUND OF THE INVENTION

There are establishments selling food and beverages, including those prepared to order. In one example, a seller of coffee and similar beverages.

At present, a customer enters a store/outlet and often joins a queue for a point of sale (POS) terminal with an order taker. On reaching the order taker, the customer verbally describes their order to an employee, who enters it for pricing. The customer pays with cash, a credit or debit card, or by referencing a brand account (including using a symbol scanned from their smartphone's display). On the fulfillment side, in the beverage example, the order taker might verbally repeat the order for those other employees actually preparing the beverage and/or might manually label hot and/or cold cups of the appropriate size with markings specifying the beverage and preparation and, perhaps, the customer's first name. After ordering, customers then must await the arrival of the prepared beverage(s) at a pickup station, hopefully taking the correct beverage or beverages, based on the name or a description of the beverage spoken by the employee placing each on the counter; a name written on the container by the order-taker; or by trying to identify their order from the appearance of those products placed at the pickup station. The customer then generally moves to another station where he or she can select “condiments” in the form of creamers and sweeteners, which they can add either there or at another location.

Customers might enter the establishment for other and/or additional purposes, which can include accessing wifi for a higher speed connection than general cellular internet access affords; for rest, a meeting, use of a computer, and/or for use of a restroom.

This present product ordering process is time- and labor-consuming and subject to errors.

### BRIEF DESCRIPTION OF THE DRAWINGS

FIG. 1 is a block diagram of the general components of the improved method and apparatus.

FIG. 2 is a flowchart of an initial process by which a customer order can be developed.

FIG. 3 is a flowchart of an initial process by which additional orders can be invited and obtained from other parties.

FIG. 4 is a flowchart operations including the capture of and trigger of the customer order and its initial processing.

FIG. 5 is a flowchart of the fulfillment process

FIG. 6 is a flowchart of a pre-arrival transfer of a customer order triggered on or about the customer's arrival.

FIG. 7 is a sample application screen for prompting the customer to order and issuing invitations to other parties.

FIG. 8 is a sample application screen for displaying the status of invited orders.

FIG. 9 is a sample application screen for acknowledging receipt of the customer's order.

FIG. 10 is a sample application screen for reporting an order fulfillment issued and offering a substitution.

FIG. 11 is a sample application screen showing correlation of a customer's order with stored profile information on which a response is conditioned.

FIG. 12 is a sample application screen showing correlation of a customer's order with an external database, such as loyalty reward points.

FIG. 13 is a sample application screen for signaling completion of order preparation and pickup readiness

FIG. 14 is a sample application screen for signaling completion of order preparation with the offer of a reward for a subsequent specified transaction.

FIG. 15 is a view of a sample beverage container showing labeling of a wrapper with customer related information.

FIG. 16A is a side elevation of a container cap.

FIG. 16B is a plan view of the cap of the previous Figure showing a label or marking thereon.

FIG. 17 illustrates a containing cap having wells for related condiments.

FIG. 18 illustrates an energy consuming appliance whose process waste heat can be used for other purposes.

### DETAILED DESCRIPTION

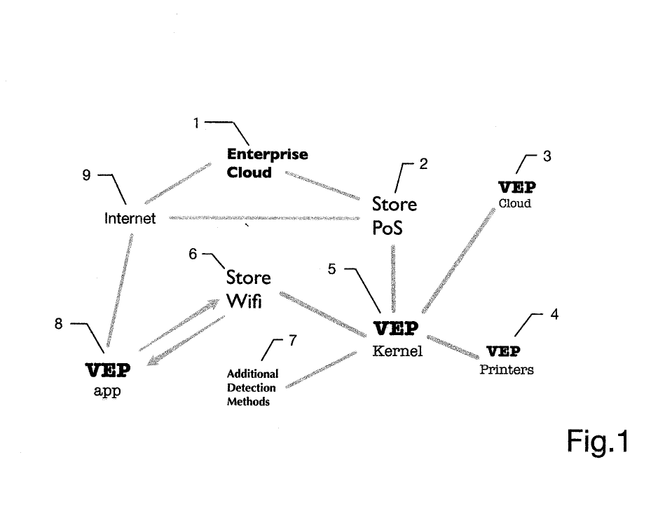

FIG. 1 is a general block diagram of one of many possible embodiments.

An improved system can employ the smartphones, tablets, and other devices that many customers have long carried, and with which they frequently interact.

An “app” for such devices (the indicated “VEP app” 8) can be provided, and for many purposes. Functions of the app can be performed within the smartphone, tablet, or other device and/or by interaction with resources elsewhere (such as “in the cloud”).

A retail establishment has premises on which orders are prepared and supplied. The premises (“store”) has at least one known point of sale terminal 6, which may be interfaced to a local server. Connections are provided to enterprise resources both on premises and, often, off premises (e.g., enterprise cloud 1) that maintain customer records (for example, accounts) and aggregate sales, inventory, and other data for various purposes.

Operating software and related data files can be integrated into general purpose resources used for ordering and billing and/or separately, such as illustrated kernel 5 and cloud 3.

Such premises often offer wifi capability 6 made available for the customer's convenience.

Such premises often include known detection resources 7 for customer and/or billing related data, such as magnetic card stripe or “smartcard” readers and bar code readers for UPC labeling of product and customer identifying data displayed on the customer's smartphone or other device and used to debit a customer account in the known fashion.

One such function, now available using both general purpose mapping software and as a feature in some brand/chain specific apps, allows the user to find nearby brand establishments/outlets and navigate to them, if not also determine whether a given location will be open for business.

It is a characteristic of food and beverage purchases that, in most cases, a given individual is likely to order the same food or beverage with the same preparation (or from among a limited number of alternatives); even more so in a given season/temperature range.

That is, their “usual”.

However, the customer will not get their desired food beverage, of the desired type, and in the desired size and variation(s) in its preparation, without a complete verbal specification of it; one understood correctly by the order-taker and passed accurately down the line to other parties in the preparation process. Different brands/enterprises may have different terms for sizes and products (e.g., tall versus small, vente versus large). And, being familiar-looking alternatives in foreign travel, such outlets will attract tourists and other foreigners who might not be fluent in the local language, much less the “beverage dialect” of ordering a global brand in the local language.

One aspect of the invention to improve the speed and accuracy of orders, including repetitive orders, for all concerned.

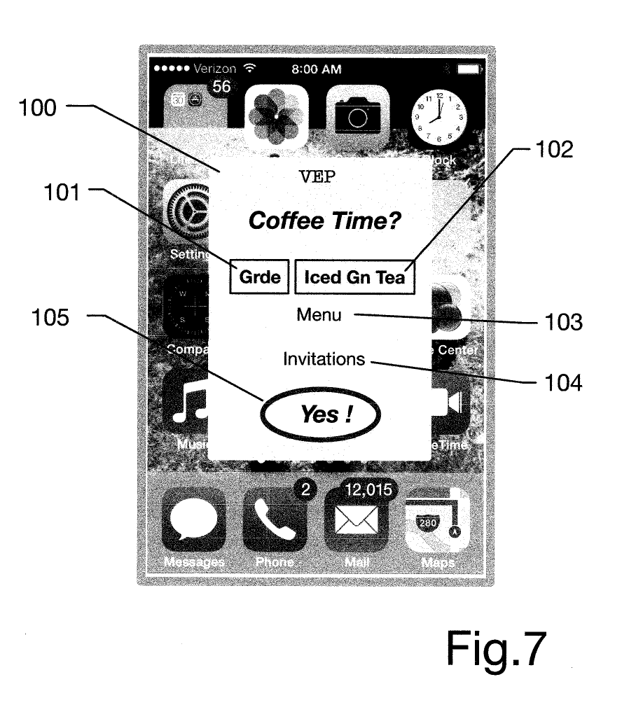

The application 8 can include a function for specifying a beverage by size, temperature, and type; including by known interface techniques like scroll wheels and auto-complete. A sample screen is presented as FIG. 7. Field 101 allows specifying beverage size. Field 102 beverage type. This both requires and facilitates a complete specification of the beverage (or other product) in a form appropriate to the product language used by a brand. The beverage specification can then be used for the next purchase, as well as being retained for future reference/use. With identification of a customer, all orders can be factored into analysis of the customer's behavior patterns, regardless of whether they are entered via the application 8, or by more conventional means, such as prior art verbal specification to a store associate via a point of sale terminal.

Over time, an application can learn a customer's preferences by their ordering history as well as its relation to month, day, time of day, location, and weather/temperature, and to present or previous activity (for example, inferring that the subject is driving by means of GPS data including its rate of change). For example, an iced drink would lead as the first suggested “usual” where temperature, ordering history and patterns suggest it would be the most likely choice. Such behavior projection 20 can include factors like day and time 21, season 22, location 23, and weather 24.

A prompt to nearby outlets for the chain can be different based on whether the user was on foot or driving, and (again based on history or a map search) their likely route.

Techniques for the aggregation and analysis of customer ordering and preferences are known.

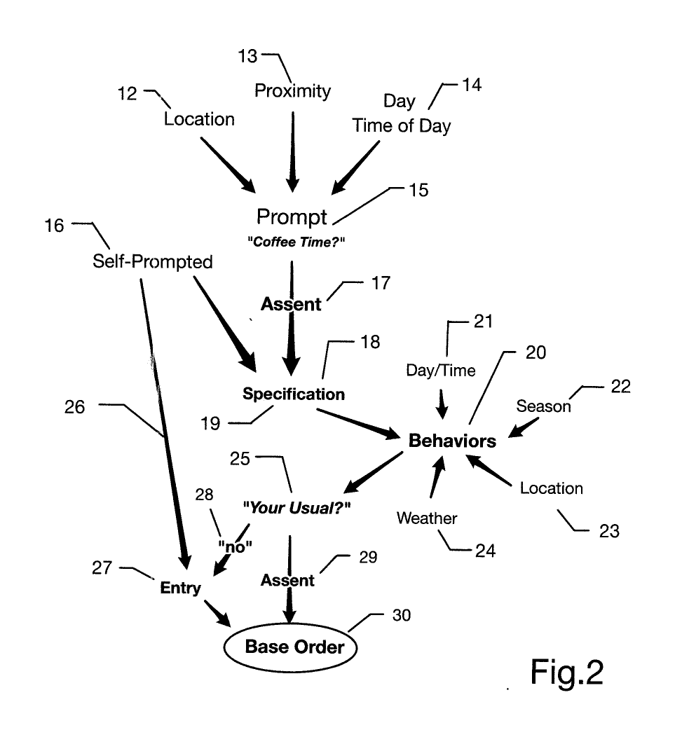

FIG. 2 is a flowchart illustrating one possible approach to the development of a customer's order.

All such Figures and example screens are for illustrative purposes and should not be understood as limiting the invention as claimed.

Relevant factors to the likelihood of customer interest in a prompted purchase can be projected from such geographic location 12 (from device GPS or other source); proximity 13 to a premises and/or travel via a historic, planned, or projected route or to a destination in such proximity; day of week and/or time of day 14 are among those that can be factored into a prospect that a customer might be receptive to the suggestion of food and/or drink. Upon such determination (which can employ software either local to the customer's device and/or at another location), the customer can be presented with a prompt 15 suggesting such food or beverage.

An example 100 such prompt screen is provided as FIG. 7.

The most likely beverage size and type (along with previously specified preparation data), based on analysis, can be offered to the customer in the fields 101 and 102, and the customer can sequence to other choices, including by sorted probability. Where a typical order includes multiple items, the “package” can be displayed with the option of editing.

A menu button 103 allows specification 27 of a new food and/or beverage from the range of possible offerings.

An Assent button 105 accepts the choice displayed. A customer can initiate the preparation of an order themselves 16, by accessing the app in their device.

Assent 29 to the proffered most likely selection; the choice of another selection; and/or the amendment of additional selections results in a specification 30 of the desired product(s).

A customer might order beverages and other products for their own consumption and/or for one or more friend, relative, or co-worker.

The invention provides for such ordering.

The example prompt screen of FIG. 7 includes an Invitations button 104.

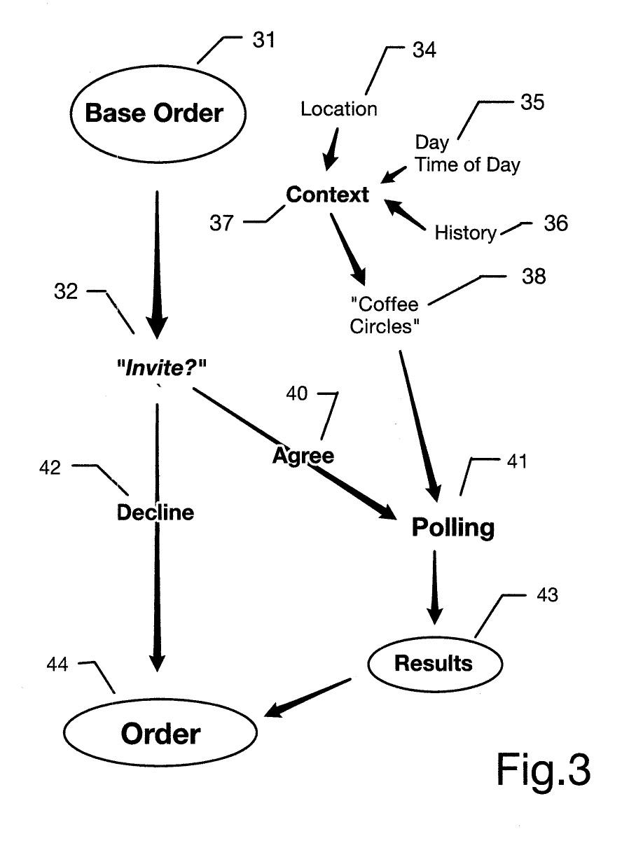

FIG. 3 is an example flowchart of soliciting, collecting, and aggregating orders from other parties. The Invitation 32, if agreed to by the customer, leads to reference to a listing 38 of other parties appropriate in the Context 37, which can include factors that identify, for example, whether the customer is or will be in the same location, such as an office or home, as well as, by consulting with personal devices associated with defined parties whether they are, in fact, in proximity—or will be at the projected time that an order is completed.

On specifying a beverage, an app can assume that a specified beverage is for the device's owner, but provide for the entry of another's name, where that product specification is for another person. Often, that other person will already be listed as a contact in a device's other applications, so that the drink specification can be linked to or associated with that other person's contact information, such that entry of a person's name or nickname in the app will auto-complete it and pull in their “usual” as the default order (subject to change). Personal preferences can be shared with other persons in the transfer of contact information between apps.

The “polling” function 41 in the example relates to communication with the other parties defined as appropriate, including by triggering the same or another app on their devices, testing their interest in food or beverage and confirming or providing for entry of their selection. The results 43 of such polling 41 are aggregated with the customer's own base order 31 to produce a combined order.

Orders can be forwarded from one to another person for their purchase on behalf of a device owner by app-to-app communication.

Orders entered by multiple customers can be aggregated for pickup by one party; that party having their own order (or not), as well as for delivery by the outlet or a third party.

A system can provide “ordering circles”: friends, family, coworkers for whom the user can purchase products. By entry and/or past transactions, the system can create groups of individuals for whom, at a given time and place, a user might order. An app can be used to trigger a poll of those listed in a group that is either chosen by the user or deemed appropriate by the user's context (location, destination, activity, day, time of day to determine whether they have an interest in product(s) and if so, whether their “usual” and/or another selection. By consent, GPS information can determine whether, in fact, the persons in a group are in the geographic area associated with a group (or specified) (for example, in the office during a workday). If they are not (and purchasing for them not practical) they can be informed of the polling/offer (in the event that they might be approaching the location, or simply to acknowledge/thank the user for their offer).

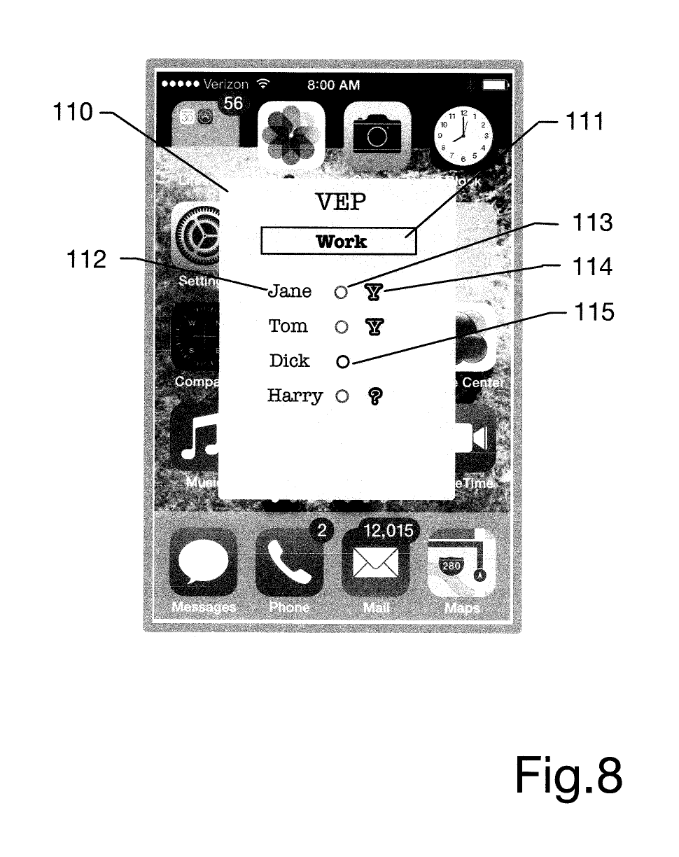

FIG. 8 is an illustrative example of a polling screen 110 in app 8.

Names for the parties defined as appropriate are listed (e.g., 112) and available for editing. Indicator 113 shows whether communication has been established with the other party's device. Indicator 114 whether a party has accepted the invitation and made a specification of the product(s) desired.

Such “circles” can be used for social media purposes and as part of rewards programs, including ties to factors including the size and frequency of purchases, for example, providing discounts or free product.

Benefits are achieved in providing, for example, refreshments to meetings and other efforts by multiple persons. An identifying code can be assigned to the order. Each person attending simply enters the order code in their copy of the app and they are aggregated for pickup or delivery. Invitations/authorizations can be distributed to persons and limits set on their purchases, and/or personal or different business accounts specified for their orders.

Use of the app allows the user to specify a beverage (and/or other choices) off the store/outlet premises, and prior to arrival, minimizing the total time required on premises. Specifications can be entered without requiring current access to the internet. The ability to order a “usual” without the reentry of its specification is afforded.

There are many methods by which an order specification can be communicated with an outlet.

For example, such outlets/establishments generally have wifi systems, many available for use by customers. And a customer's wifi-enabled device is alert to its local wifi “environment” for potential connections. Some such wifi connections are public, requiring only their selection and a login accepting the terms of use.

One annoyance is that the customer's use of their smartphone or other device might be interrupted when it “sees” the outlet's wifi system, as well as those of others. In any event, the customer can be required to accept the terms of the outlet's login screen, although the same customer has always logged in at the same brand's outlets, if not at the current one. Some establishments, to prevent “internet loitering” by non-customers provide daily log-in keys to those making a purchase, for example by printing it on the POS register receipt, which limits wifi use to after the receipt is received and the access code on it is found and entered.

Preferably, the application (or a feature of a more general wifi/communications app) watches for a wifi signal from a system from the desired brand's outlet. On seeing such a signal (meaning being in proximity to such an outlet) the two can handshake and any pending order by the customer be sent to the outlet's system either automatically, or with the device's user being asked to confirm that the order should be sent. Authorization to access the wifi hotspot and a standing acceptance/acknowledgement of its terms of use can be made automatic.

By wifi (or other means) a customer's order is made available to an outlet's system(s) on or before entering the premises (or approaching a drive-up window). No customer or employee interaction is necessary. The order is complete, correctly specified and formatted, and identified with not only the customer's first or other name used for identifying the prepared beverages and/or other products, but more specific identifying information that can be used for billing/payment and for analysis.

Although the customer can pay by cash, many users prefer the use of a brand account, or of a credit or debit card, to avoid the use of cash, which also has advantages to the brand in transaction time and labor. A card reader, for magnetic stripes and RFID chips on credit/debit/brand loyalty cards, can be installed at an outlet's entrances, as well as the head of the drive-thru lane, as well as a reader (presently at the register) for capturing display of a code on a smartphone screen that identifies to the user's brand account (in the current manner). The customer can thus swipe or otherwise provide a validated charge instruction immediately upon entry, speeding their purchase. And/or, with suitable safeguards, interaction between a customer's device and an outlet's system(s) can include authorization for a charge of the transaction to the desired account(s), including by prior preference/specification; contingent on whether the purchase is made for business or personal consumption; and/or with all or part of the order charged separately to the accounts of others.

The arrival of a specific customer can be detected by many means, including data transmitted by their cellular phone, smartphone, tablet; a card swipe or RFID; facial recognition, and/or scanning license plates at drive-up.

The transmission of order specification need not be made by wifi or other local broadcast connection. For example, some brands offer apps that present a 2D code pattern on the device's display, one read by another device linked to the outlet's system for payment purposes; a reader presently located at the POS terminal. A pattern or other display can encode not just the user's identity (thereby linking to an account for payment), but the pending order's specification so that the latter is communicated to the outlet's system. And readers can be located at one or more locations near the point of entry (including at the head of a drive-up lane).

An order specification can be linked as a text message via cellular or a transmission by internet access other than a given outlet's wifi and routed either to a specific outlet (based on choice, precedent, and/or proximity) or to a group of outlets (or their shared network) with the user's choice of outlet and thereby initiation of order fulfillment confirmed upon the user's arrival at one outlet by sensing proximity or location; by a card swipe, RFID or other “check-in”; or by other means.

The customer can pre-send (or schedule routinely) an order for pickup at a requested time, which permits the order to be staged in an outlet's system for release and preparation, back-timed for completion at the requested pickup time, given outlet workload/traffic. With the customer's permission, GPS feedback of customer location and travel progress can permit predicting arrival time and scheduling order preparation thereby.

A user can, by any of these means, order and pay without interaction with an employee, dramatically reducing time, labor, and errors. The speed, ease, and accuracy of the transaction provide an “express lane” or “VIP” level of service, reducing lines and increasing throughput. The result is an incentive for a smartphone, tablet, or other device user to patronize outlets of a brand with this capability, and for those patronizing it to employ the app/capability, to the benefit of all.

By avoiding the need to verbally enter an order, and to queue to do so, the appeal further increases in high traffic areas and periods. With the ordered “entered at entry” the customer can use a restroom, find a seat, and/or catch up with calls and emails pending the arrival of their order in the pickup area. And a customer already seated in an establishment can enter an order without standing in line.

Order preparation may be prioritized by time/order of wifi exchange; the time-stamp of a physical charging/validating swipe or other action on entry; and/or taking into account the relative time required for the preparation of the items ordered or subsets thereof. In the case of wifi and other broadcast signals, methods can be employed to physically locate the device (including but not limited to GPS) and thereby the user in establishing priority.

Determination of entry time/priority can also be of value in circumstances where persons are served in the order of entry, such as deli counters and waiting rooms. Informal systems of queuing or the use of serially numbered tickets are now employed. A system using such personal devices to establish priority (supplemented by tickets or other means for those without such devices) is possible.

Systems can employ feedback from an outlet's system(s) to a user's device for various purposes.

Some will be described below in the case of receipts and other records of payment.

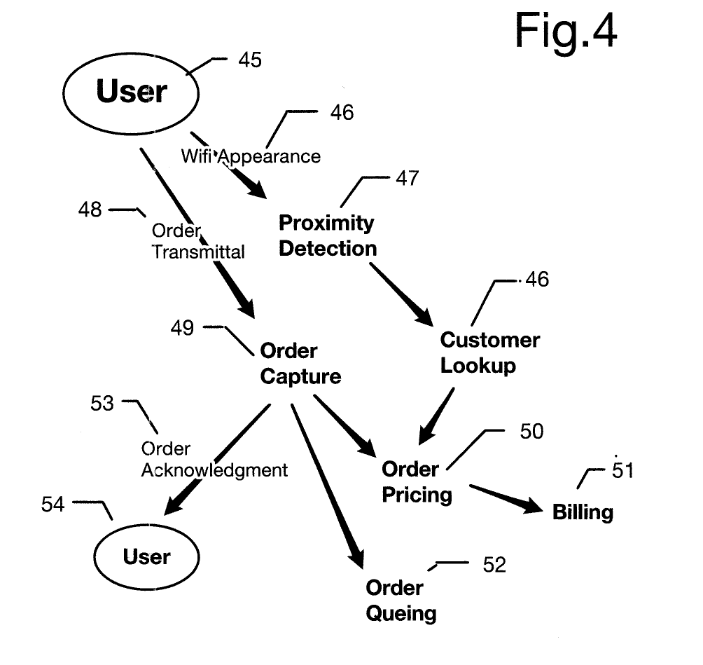

FIG. 4 is an illustrative example flowchart of operations in and around the premises where the order will be prepared. User 45 is determined to be in proximity 47, for example, by detection 46 of a wifi or other radiation from the customer's smartphone or other device. Such detection can trigger access 46 to relevant data about the customer as well as transactions that capture 49 the details of the user's order. With such order capture 49, the order can be priced 50 and billed 51, as well as placed in queue 52 for physical fulfillment. An acknowledgement 54 can be returned to the user's device to confirm that the transfer has been accomplished.

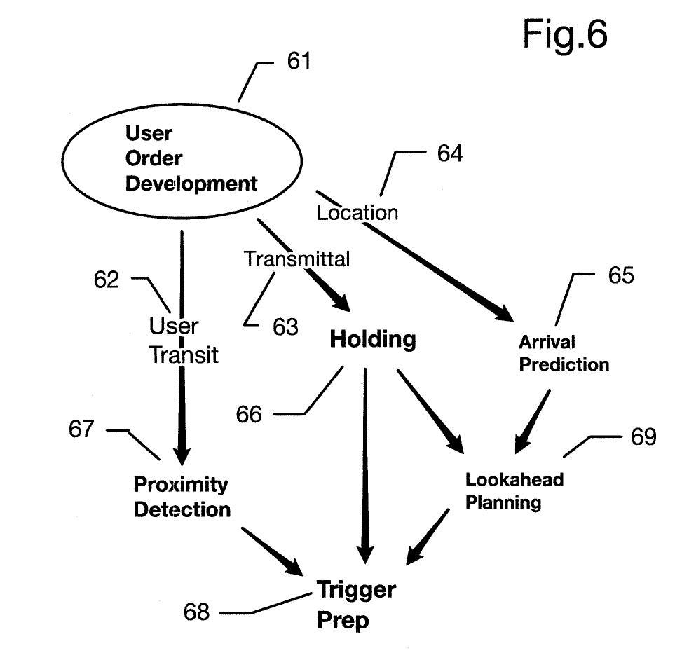

FIG. 6 illustrates examples where, as described, a customer's order can be developed 61 prior to their arrival in proximity to the preparation/pickup location. The order can be transmitted 63 and held 66 pending the customer's arrival as detected 67. Where appropriate, planning 69 for the order can be done, including on prediction 65 of likely arrival time, which can be based on real-time and/or time stamped 64 GPS location data. Detection 67 and/or prediction of arrival can trigger 68 preparation of the order.

Such detection can include, as described, such additional detection methods 7, such as a card swipe, chip, and/or bar code reader located not at a point of sale terminal (requiring waiting on a line) but at or near an entry to and/or on the premises and/or a drive-up lane; as well as license plate or facial recognition.

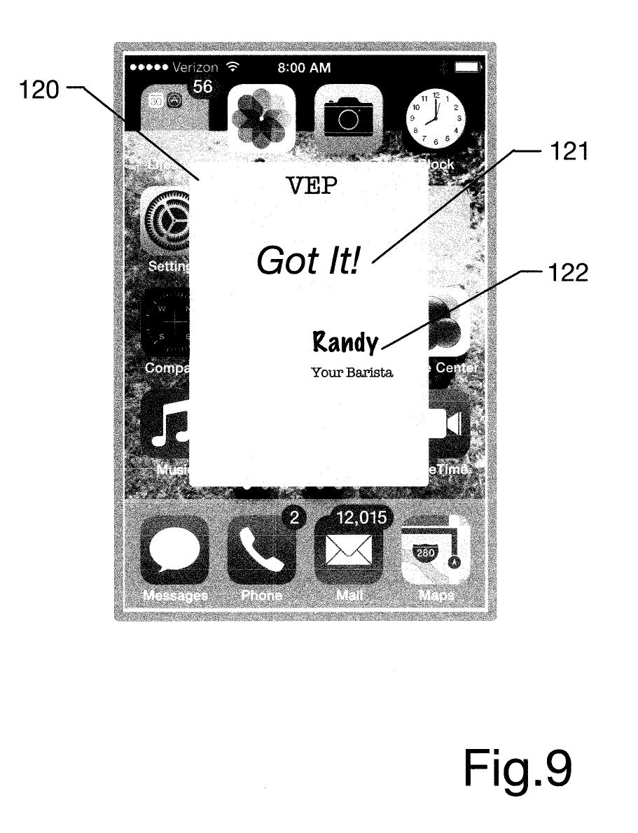

FIG. 9 illustrates a sample such acknowledgment screen 120.

Capture of the order allows for comparison with current or projected inventory and, where practical, determination that a given item cannot be supplied.

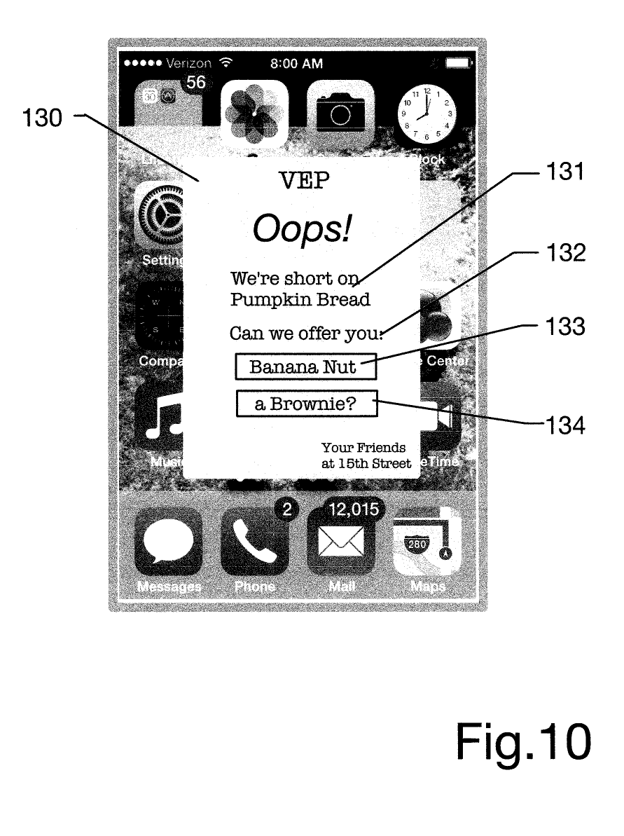

FIG. 10 illustrates an automated response to such shortfall, noticing the customer 131 and, where appropriate, offering 132 a substitution for the selection (via buttons 133 and 134 in the example).

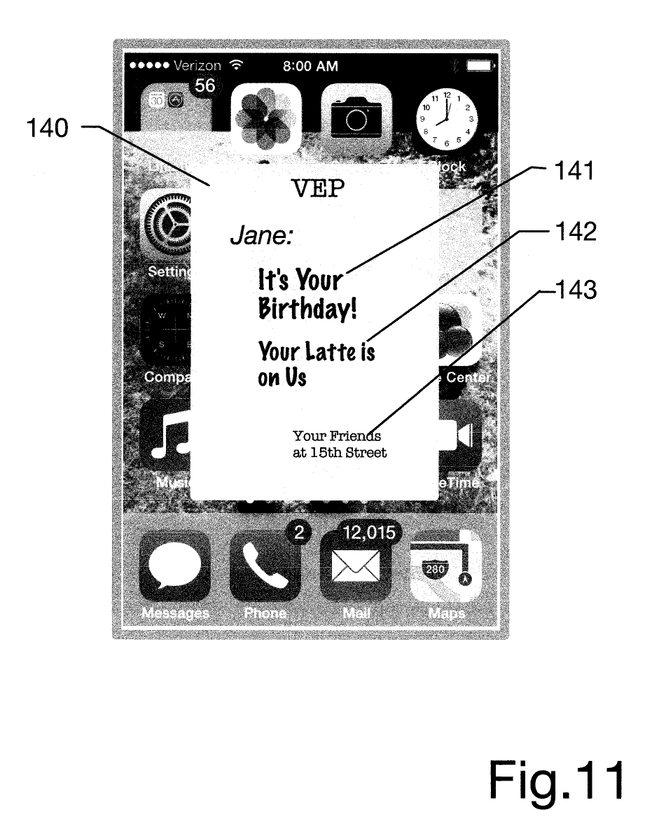

FIG. 11 illustrates the coordination of the customer's order with customer data. Here, the customer's birthday has been identified and a free drink provided.

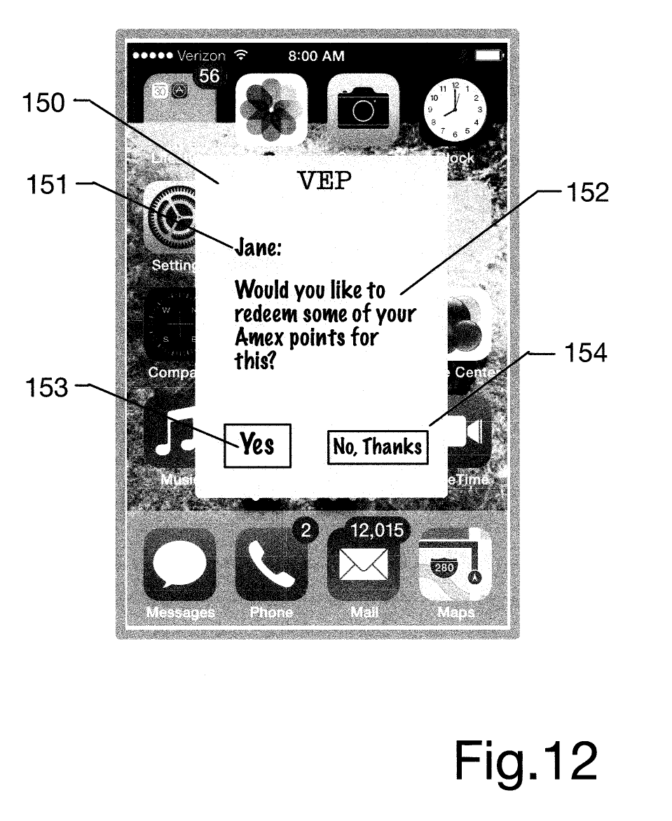

FIG. 12 illustrates reference to another database, in which credit card rewards points are available and their potential use is offered to the customer.

Other uses include asking the customer for clarification/completion of an order; informing them that an item is “sold out” and offering alternatives; special offers, loyalty program updates, the current music selection in the outlet; and sending personalized messages. The customer can be noticed when their order is ready, as well as to the availability of restrooms and other facilities.

Another feature is translation services. A customer's preferred language is established in their device. In addition to translating the customer's selection as entered in the app in that language, where items are available locally, not offered in their home area, those local choices can be added at (or prior to their arrival) and named, pictured, and described in the app, such that the user can decide among them, and identify examples on display by name, ingredients, calorie count, etc. Bar, QR or other codes can be scanned and trigger a lookup of a product.

Use of such an app for ordering in a foreign outlet speeds the process, reduces error, and increases customer comfort.

Identifying customers and linking to data regarding them, including their profile, allows personalized greetings and other individualized interaction by employees.

Another application for communication from an outlet's system(s) include receipting/accounting.

In some circumstances, all or part of a purchase may be reimbursable and/or deductible as an expense, requiring an accounting for the purchase for expensing and/or tax reporting. In terms of payment, where an individual purchases product for others, products might be a “treat” by the purchaser, or be reimbursed by those others. This, of course, leads to the difficulties of determining the respective amounts owed by each to the purchaser.

The present invention allows selecting, in the specification process, whether a purchase will be expensed/deducted (which generates a record that can be input into other applications) and/or whether a purchase made for another will be reimbursed (in which case the amount due from or for each other person can also be calculated).

In the transaction, purchases can be linked not only to the user's account(s) or credit/debit card, but to different accounts depending upon whether a purchase—or that portion of a purchase—is for a business purpose (and chargeable to a business account) versus being for personal consumption. Similarly, where a user makes purchases for others for which they will be reimbursed, brand accounts, business accounts, and/or personal cards or accounts for those others (with appropriate safeguards and permission) can all “direct bill” (with or without an approval step by those others) those purchases made on their behalf.

Another aspect of the ordering process is that of receipts. A customer may want a receipt to confirm that a charge to a card or brand account is in the correct amount; to submit for reimbursement and/or a deduction; and/or for reimbursement of purchases made for others. Presently, this is by means of a paper receipt generated by the POS terminal. An outlet can present a receipt to every customer, which is an expenditure of time and paper and an annoyance to those customers with no wish for one. Conversely, an outlet's servers can ask customers whether they want a receipt, which adds to the transaction time and represents another specification to the order that may or may not be fulfilled. The paper receipt itself must be handed to the customer, and it may be lost, torn, or damaged by exposure to liquid. It must be retained, filed, and later recovered for use by the customer.

Alternatively, the choice of “receipt or no” can be made part of the pre-order process, including by customer choice for the upcoming purchase, a default choice for all purchases, and/or dependent on whether other selections identify the purchase as being later accounted for and/or reimbursed.

The function of a receipt can be enhanced in a paper and/or a paperless model.

In the example when a purchase is being made for multiple parties, the name or other identifier for each party can be printed with the item to help in distributing the products and accounting for them.

In fact, in addition to a total for all purchases, for the convenience of the customer, an extended receipt can be requested with subtotals, by name, for each reimbursement, which includes, for example, pro-rated sales tax in the calculations, as well as (if desired) a pro-rated contribution towards the products that will be consumed by the person making the pickup for their effort.

A paper receipt need not be generated. By virtue of the communication between a user's device and an outlet's system, the latter can return to the former for display item prices and a total based on current prices (which can vary from outlet to outlet). The total can be presented to the user on their smartphone, tablet, or other device as a confirmation of the total charged (with or without an approval step). The electronic receipt (including order details, prices, outlet, and time/date stamp) can be retained in the app and/or on a website for viewing, printing, and/or transfer to another program or application. The accounting can fold in discounts and awards points based on various factors, as well as updating the customer's rewards/loyalty account and transaction history.

The disclosed approach allows the capture and analysis of information for the outlet and/or brand. In addition to capture of the order, the app can feed preference information, as well as survey of ordering patterns for the user and for others, whether those are customers with their own accounts or not. Time stamps at several points in the process, including the first wifi, scan, email, or text exchange; on physical entry/swipe or other detection of arrival and/or charge-authorizing transaction; and at stages in order preparation, provide precise information on the efficiency of the outlet. With sufficient range (and subject to privacy policies) the system can note the occasions on which a customer with the app passes any brand outlet, even if they do not order from it. Interaction with GPS location allows charting proximity to outlets even if outside of wifi range, as well as prompting a user when in proximity to an outlet or where their route will bring them near an outlet—offering the opportunity to visit the outlet. Such information also allows surveying the prospects for a new outlet location, including not only an established customer's daily travels, but its time-wise relationship to their ordering behavior.

Prompting is a function related to data gathered on a customer's behavior patterns, including beverage orders and time of day as related to location/activity (for example, on work days versus not; during commutes) and on temperature.

If a customer often purchases a beverage at a given time of day or other identifiable conditions, the customer can be reminded that their “break time” is approaching and prompted to ask whether they would like their “usual”.

Polling is another capability that increases sales. When a customer buys product for others, for example, in the workplace, a function (which can be based on prior behavior) can ask the customer in prompting (based on time of day and/or location data) whether they would like to “ask” others whether they want product. Manual entry can be offered for orders for other persons (defaulting to their own “usual”) including based on ordering patterns and/or location data that suggest those others are likely nearby—as well as text and email solicitation of other persons that would pop up an alert (including but not limited to out of that other's copy of the brand app) asking “The usual?” on behalf of the initiating customer app. That other would then have the choice of accepting the offered product(s) choice, changing from and/or adding to the default offer, or responding “no thank you”. Plainly, this is not only a convenience, but stands to increase purchases per transaction; which, in turn, are simplified and errors (and with them frustration) reduced by the other functions of the app. Known apps that permit a user to determine by consensual GPS data comparison which other persons are in physical proximity can be used to “extend the offer” as well as to initiate a “let's have coffee” suggested meeting.

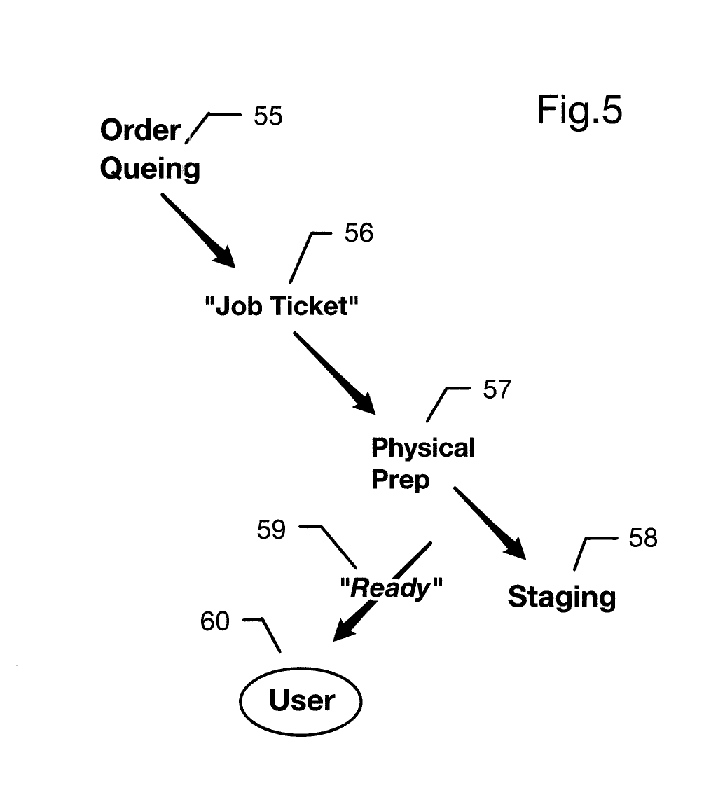

FIG. 5 is a illustrative flowchart of the physical preparation phase of an order.

The queue order 55 is used to produce a physical “job ticket” 56, to which the preparer(s) can refer. This may take the form of a printed form; labels applied to or printed on a cup, lid, or container; and/or visual and/or audible prompting as previously described. The order is prepared 57 in the usual manner and, typically, placed 58 at a pickup station for the customer's collection. Notice of completion and/or projected completion of the item and/or order can be generated and used in process control and analysis, as well as to signal 59 the customer via their device that the item or order is ready for pickup.

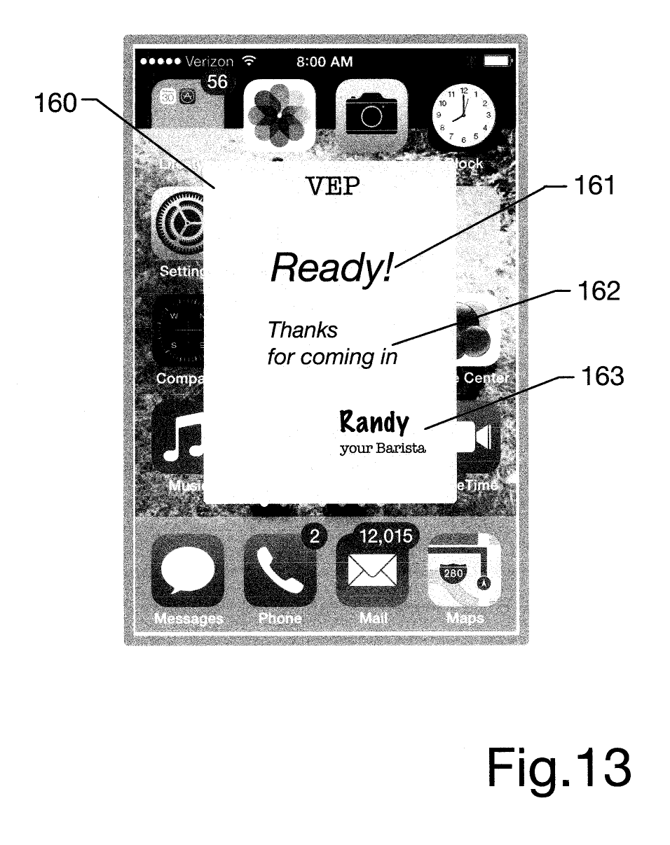

FIG. 13 is an illustrative example 160 of such a screen.

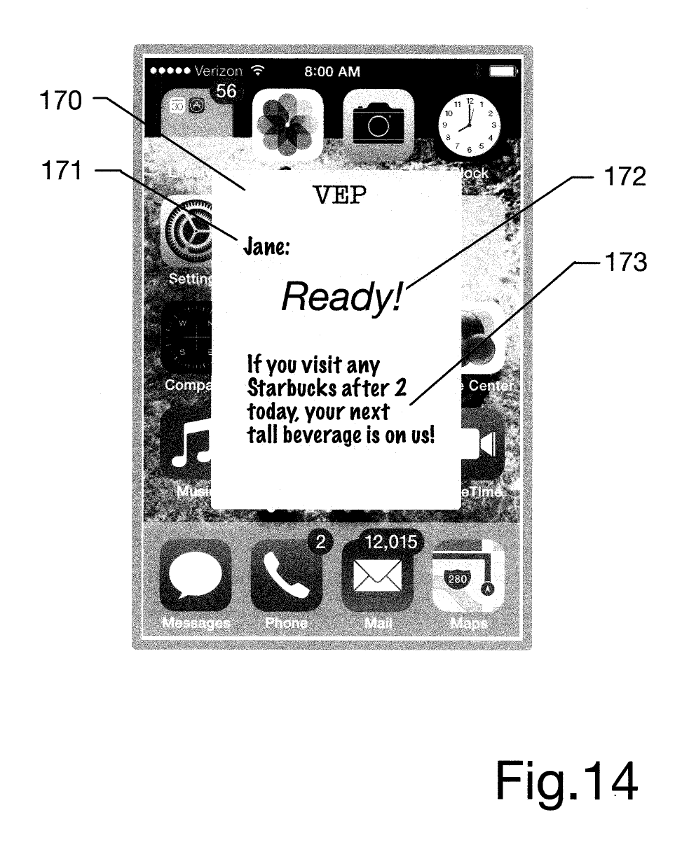

FIG. 14 illustrates that such screens can include notices, including of promotions and rewards to encourage subsequent purchases.

In the preparation of a customer's order, an outlet might mark the cup(s) or container(s) with specification information for beverage type; markings referred to in preparing the beverage and in identifying it when complete; and/or with the ordering customer's name.

Using the disclosed approaches, identifying the product(s) in outlet orders can also be simplified and made more efficient. An order is entered into the outlet's system(s) with the first or other name of the customer to identify product(s). A terminal or other means can then be used to display the product specification and customer name, so that the correct cup/container can be selected and marked appropriately by an outlet employee.

The specification for a product and the customer's name can be printed on a label, which is applied to the appropriate cup or other container or package, and can be referred to in selecting/preparing the product. The customer name, in large print, can be used by the customer to identify/select their product(s) from a pickup station and/or for the preparer to hand the product to the right customer.

When the same or similar customer names appear in the system, for example, when two Jims have orders in process, the names can be differentiated, for example, with a last initial.

When one customer is buying for several people, a label can include not only the purchasing/pickup customer's name, but with the name of the other person for whom each item is ordered, so that the total purchase can be distributed correctly on delivery. (A capability to “batch” product orders can allow assembling/packing/delivering products by area, for example, by work area/department, is also possible).

It is not necessary to use labels applied to or hand marking of cups and other packaging. Several techniques (such as the relatively long-range inkjet marking used for items such as cartons moving along an assembly line) can be employed to mark directly on cups and other packaging. Another approach employs the paper sleeves often supplied with the beverage/cup to insulate the customer's hand from a hot beverage or to absorb condensation from a cold one. (At present, such sleeves are generally pre-printed with the brand's logo and related text, or with a paid advertisement.) Sleeves can be fed through a printer linked to an outlet's system to be marked with the buyer's name, beverage specification, and other data. The sleeve can be referred to in the selection of cup or container, in preparation, and for pickup. And it can be printed (including on/with a detachable portion) with/as a receipt. Sleeving can be roll or accordion fed; trimmed and/or sealed to different lengths for different sized cups/containers; incorporate peel-off portions; and/or be printed on all sides.

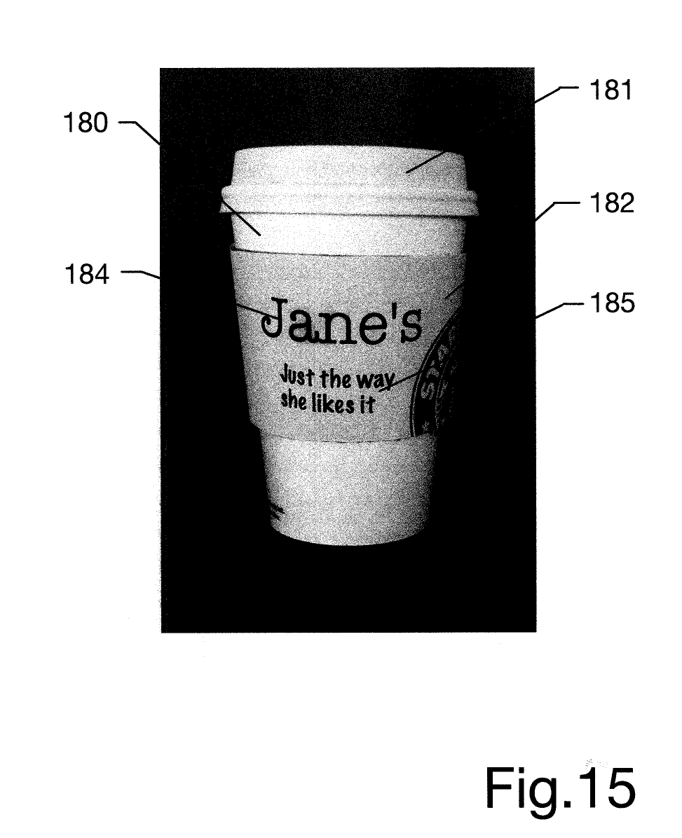

FIG. 15 is an illustrative example of such marking using a sleeve 182, which prominently presents the name selected by the customer 184, and provides for additional features including the details of preparation, logos, and messages (such as 185).

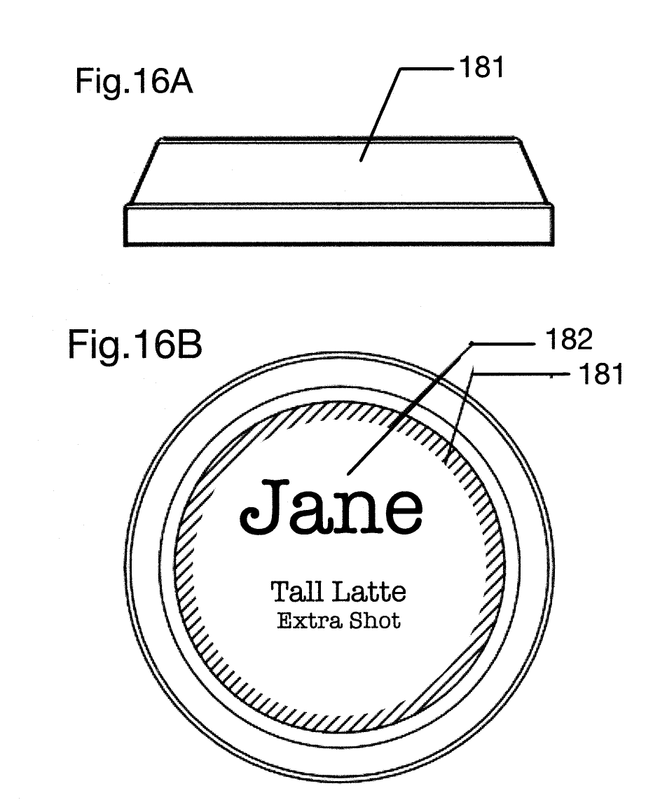

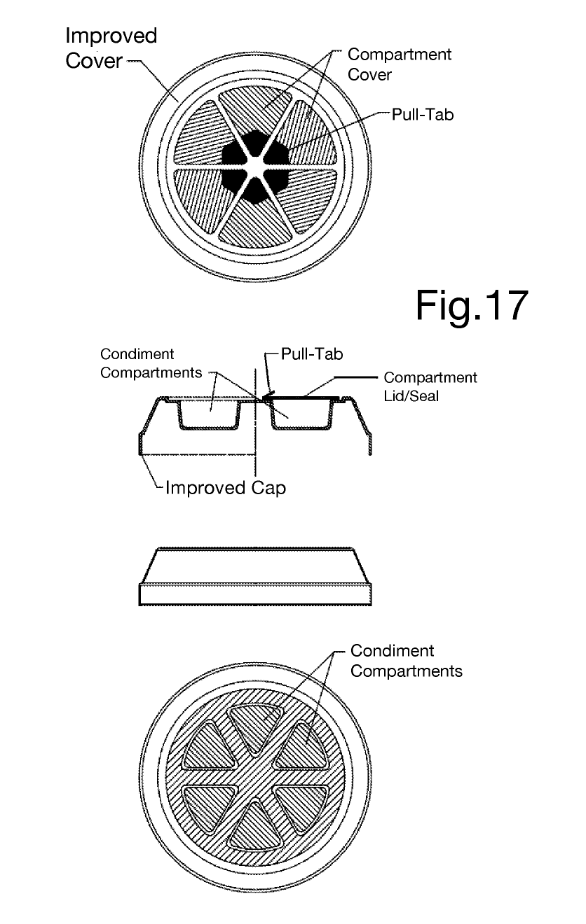

FIG. 16 illustrates labeling or marking of a container lid.

The capability to print/reproduce on a container, sleeve, and/or other item placed in the customer's hands affords opportunities to advertise and promote not only the outlet's brand, but to derive revenue from advertising and promoting for others (including coupons). Advertising and promotion messages can be particularized by customer, context, or other factor. For example, a customer with a home area zip code or history of transactions at distant outlets can be inferred as traveling beyond their normal range, which may suggest messages and offers appropriate to their needs/interests as a traveler. Assignment of a purchase to a business as opposed to a personal account suggests a business trip. Messages and offers more relevant to upcoming activity, time of day, climate, etc. can be selected.

The identification of the customer allows links and associations with larger and other databases beyond a brand's own that allow targeting advertisements and promotions. Personal preference information derived from interactions with the brand and with other businesses that capture or project a customer's actual or likely interests can be used to, for example, select the message delivered. Targeted messaging is potentially more effective and, therefore, valuable. A customer's purchases in one brand's outlet can be linked to their relationship with other businesses. Linkage of loyalty programs and promotions across brands such that, for example, a purchase at the outlet can redeem—or generate—loyalty rewards from other companies (a credit card, an airline) or access their promotions.

Although the approaches have been described in the context of one brand and its products and outlets, they may be employed for multiple brands in the same and in other market segments. The interface for each brand can be tailored not just to its suite of product selections and ordering “dialect”, outlets, and payment methods, but logos, color schemes, and other brand identity choices.

A user could chose from among the several brands offered, based on their interest and experience, including by ranked order of desirability as well as relative proximity. The application can also derive cross-brand preference information that assists in analysis of brand appeal.

The improvements disclosed can be integrated into the business systems of a brand and its outlets, as well as in third-party system that businesses can buy or lease. Such systems can provide for revenue flow through the brand's accounts, or can process and clear payments as a service, returning to the brand or outlet net revenue.

In addition to visual/text-based prompts of product specification, a voice-synthesis prompt can guide the preparer. The operation can begin with a “spoken” prompt for the desired cup/container size/type, which the employee picks up. This cup/container could be briefly held against a fixture that applies a label or prints directly on it, or the employee receive a voice prompt that specifies the product/preparation, which the employee marks on the cup/container in the current fashion.

The voice prompt saves time and does not require attention to a display. Multiple, separate channels of voice prompt can lead several employees through the sequence required to prepare each product without confusion with other orders/employees/preparations taking place in a common area at the same time.

Selection, if not marking, of cups/containers can be made automatic. A dispenser can contain multiple wells, each accommodating a different cup/container, in one embodiment, bottoms up. In the manner of plate dispensers used in food service, each stack of cups/containers can be urged upward. An indicator, for example an LED-illuminated ring around the cup/container stack can light, indicating the next size/type to be selected. On sensing the cup or container being picked up by the employee, the employee can be prompted by a display or voice prompt with the next relevant portion of the specification to its preparation. At the start of a preparation, a print head or label applicator can mark the topmost cup or container in a stack, as it is presented to the outlet employee for filling. Alternatively, multiple stacks of cups or containers can be retained in the dispenser and the next size required plucked from the appropriate stack of such cups, including being presented to a shared marking means before presentation to the preparer.

Another candidate for prompting the correct preparation of a beverage is the cap for the cup, to which a label can be applied or on which a label can be printed. The cap, which can be automatically dispensed, provides the preparation specifications and a name or identifier for the customer, which can be readily seen by both staff and the customer at the pickup station.

RFID, bar code, or other identifiers applied to a cup or container can be used.

For example, cups, containers, and sleeves can be provided or labeled with markings, RFID components, or other means by which each may be identified. A product order/preparation specification/order can be linked to a cup/container by its identifier that “follows” it through preparation and delivery to the appropriate customer. The specification for a product preparation can be “written” to the identification means carried by the cup to be “read” at other stages in the preparation, or a pre-assigned identifier supplied on the cup/container can be associated with an order, such that the sensing of the identifier at points in the preparation and delivery process trigger a recall of the specification and other data and its presentation to an employee or automated operation (including edited to those aspects relevant to the current operation). At the pickup station, a cup or container can be placed on a pad or area that will then display the customer's name.

Another improvement relates to the use of “condiments” such as creamers and sweeteners. At present, the preparer might add these items to the base beverage following on a further verbal specification by the purchaser. Alternatively, the base beverage may be presented for transfer to the customer's custody, who then selects and adds condiments at another station/location in the outlet, which station offers a selection of creamers, sweeteners, and other condiments. This is an additional operation for the customer; can involve another wait for access to the condiment station in high traffic periods; generates waste; and requires frequent restocking of condiments and cleaning of the station. Further, some condiment additions benefit by provision in the preparation of the base beverage, for example, filling the container less than full to allow room for creamer. (A request for “room for milk” might be added in ordering by the purchaser, which adds to the specification.) Alternatively, a customer may chose to select packages/containers of condiments for later addition outside the outlet, prior to consumption. This requires selecting the appropriate kind and quantity of condiments; resulting in customers taking more than needed, increasing costs and restocking frequency. Beverage leakage in transit can also spoil the paper packages in which sweeteners are supplied.

Regardless of who adds the condiments, the correct kind and quantity is important for customer satisfaction for reasons of taste preference, diet, and even allergies. Improvements to this aspect of the process are desirable.

The specification entered by the application can include the kind and quantity of condiments for each product. As much as the likelihood that a customer will tend to order products, including beverages, from a limited number of preferred selections (“usuals”), the choice of condiments for each such preferred product is generally very stable. Therefore, the choice of condiments (as well as other details such as room for creamer; a preferred temperature; and other preferences) can be made part of the ordering process, the product specification, and the information transferred to an outlet for preparation. Verbal description is not necessary. The condiment/preparation specification can be applied to the cup/container and/or a preparer prompted by display, voice prompt, or other means. Where products for multiple persons are being purchased their own preferences can be accurately tracked through and referred to, whether condiments are added by employee or customer. The kind and quantity of packaged condiments can be totaled and used to dispense, whether manually or by a mechanical device, the correct kind and quantity of condiment packages; reducing both wastage/excess and errors.

In addition, the condiments can be dispensed into the cup/container in powdered or liquid form. Bulk supplies of creamer product, sweeteners in powder or syrup form, and other condiments (e.g., cinnamon and cocoa) can be held in a dispensing unit. When a cup or container for a product is in or under the dispenser, specified quantities of the desired condiments can be entered.

Although the present invention is described in the context of the sale of beverages and other products, it will be understood that the same methods may be applied to other products and situations.

One such case is vending machines. An “app” can permit navigation to a vending machine, and status information reassure the customer before arrival that the machine is functional and the desired product available. The techniques of more efficient order specification, payment and payment alternatives, and transaction analysis can be employed. A modern “automat” can use the address/device recognition techniques described so that a customer indicate a desired selection, unlock the compartment, and debit their account, including by pre-ordering items, which would be reserved.

### Efficiency Improvements

In preparation of food and beverages, whether in commercial or personal/home environments, energy is consumed in changing the temperature of product and its ingredients, including

Improvements can be made in the use (and reuse) of resources/consumables/energy among and between what have been traditionally viewed as separate functions and fixtures and/or appliances. And fixtures and appliances can be packaged in forms more efficient both to transport and install.

In one example, refrigerators create a “micro-climate” of lowered temperatures in which food can be preserved. Most such units package a compressor in the housing that circulates a working fluid/gas between the insulated interior and the compressor and a radiator from which heat extracted from the interior is dumped into the immediate ambient air around the unit. This adds to the heat load in the immediate area (often along with that from other heat-generating appliances), which can require transfer from the interior to a building exterior by ventilation, if not air-conditioning.

Other micro-climates are produced using ranges, ovens, stoves, toasters, microwaves, etc.

Heat/energy generated and/or transferred by and for such a micro-climate can be used for additional purposes, and/or transferred outside the immediate area.

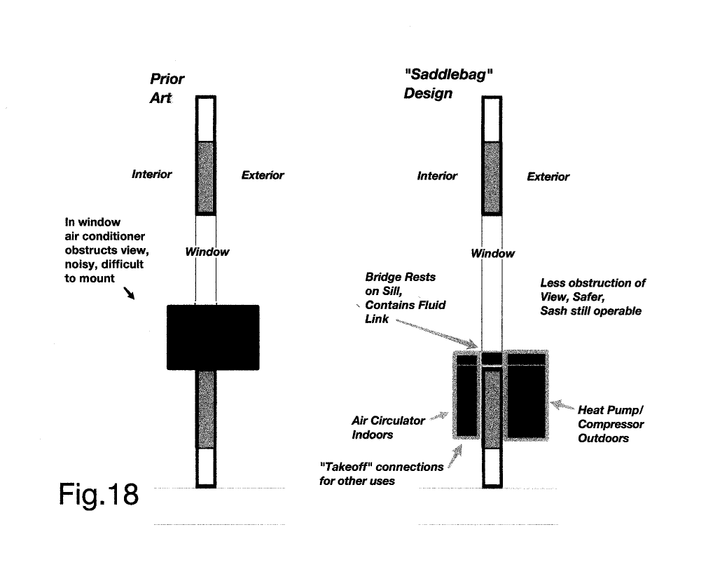

Refer to FIG. 18.

Typical window-mounted air conditioners are noisy, obstruct the window, prevent opening the window sash, and are difficult to mount. “Split” air conditioners are known in which the air-handling function remains in the interior and the compressor/heat pump is packaged separately and mounted external to the space; the two connected by plumbing with the working fluid/gas.

In FIG. 18, the functions are split, but the two halves are packaged connected by a structural “bridge” of adjustable span, one that sits atop the lower edge of the window (or other) opening, and encloses power, working fluid, and control connections between the two portions, such that a unit with the advantages of “split” construction can be quickly and easily installed by a user. Audible noise is reduced and the external portion of the unit can be vibration-isolated from the bridge to reduce its transfer.

The illustrated embodiment includes a “takeoff”, which allows the connection of additional components to the compressor/heat pump, which might be another air-handler and/or a refrigerator/freezer, such that heat otherwise dumped into the local ambient is exported beyond the occupied space and the efficiencies and economies of the shared resource can be achieved.

The same (or another) technique can be used to couple the heat transferred from a chilled “micro-climate” such as a refrigerator to the exterior of a space—and economies achieved by using a common compressor or heat pump for both micro-climate and indoor ambient cooling.

Heat generated by one process can be used as an input to another desirable process instead of being wasted (if not generating additional energy demand by requiring further transfer outside the immediate area).

For example, a compressor can be thermally linked to a store of water (potable and/or grey) to prevent radiation of transferred and processed heat into the local ambient and provide warmed or hot water (which would otherwise require the expenditure of still more energy to produce). Waste heat from a micro-climate transfer The scope of this and other inventions disclosed herein should not be understood as limited to the example embodiments and descriptions here.

The inventions disclosed herein should not be understood as limited, except by the scope of the claims.

1. (canceled)

2. A system for polling and consolidating orders for beverages individually prepared by an enterprise to a specification by a customer,
said enterprise having at least one premises,
said beverages prepared on said premises,
said enterprise having a stored program order management system,
said customer having a portable personal electronic device,
an interface including said personal electronic device and said enterprise system permitting order entry by said customer via said device wirelessly while distant from said premises,
the improvement wherein said interface has access to at least one listing of additional said customers, and
wherein said customer can initiate an automatic poll of said additional customers via said personal electronic devices of said additional customers as to their interest in ordering a beverage from said enterprise, and
and wherein the results of said poll are automatically collated by said interface in a multi-customer order to be prepared on said premises.
